(19) United States
(12) Patent Application Publication
(10) Pub. No.: US 2013/0332219 A1
(43) Pub. Date: Dec. 12, 2013

(54) DISCOVERY METHOD AND DISCOVERY SYSTEM USING LOCATION-TIME INTERSECTIONS

(71) Applicants: Victoria Clark, Ashburn, VA (US); Jeffrey White, Purcellville, VA (US); Guy Decorte, Bend, OR (US)

(72) Inventors: Victoria Clark, Ashburn, VA (US); Jeffrey White, Purcellville, VA (US); Guy Decorte, Bend, OR (US)

(21) Appl. No.: 14/001,020

(22) PCT Filed: Jun. 1, 2012
(86) PCT No.: PCT/US2012/040471

§ 371 Date: Aug. 22, 2013

Related U.S. Application Data
(60) Provisional application No. 61/519,896, filed on Jun. 1, 2011.
(60) Provisional application No. 61/634,457, filed on Feb. 29, 2012.
(60) Provisional application No. 61/634,590, filed on Mar. 2, 2012.

(51) Int. Cl. G06Q 10/10

(52) U.S. Cl. CPC G06Q 10/1095
USPC 705/7.19

(57) ABSTRACT

A system for providing predictive discovery services to a user. The system includes a mobile, hand-held device having a display for displaying and storing information and a user interface for allowing input of user interest data comprising event and product preferences, user interest criteria, current hand-held device location, and event calendar information about future occurrences and locations for events and products; a database(s) remote from the hand-held device for storing the user interest data; a processing device in data communication with the database that is structured and arranged to identify a proximity boundary near the user's current and future locations; and a data mining device that is adapted to identify factors of discrete interest for the user based on the user's historical, expressed interests input on at least one remote accessible Web site.

### CROSS REFERENCE TO RELATED APPLICATIONS

The present application claims the benefit under 35 U.S.C. §119(e) of U.S. Provisional Patent Application 61/519,896 filed on Jun. 1, 2011 and entitled “TimeRAZOR”; U.S. Provisional Patent Application 61/634,457 filed on Feb. 29, 2012 of the same title; and U.S. Provisional Patent Application 61/634,590 filed on Mar. 2, 2012 of the same title.

### STATEMENT REGARDING FEDERALLY SPONSORED RESEARCH OR DEVELOPMENT

Not Applicable

### BACKGROUND OF THE INVENTION

Methods and systems for providing discovery services to travelers, tourists or users in a familiar or unfamiliar environment are of increasing interest. Modern selling tools such as promotional advertising concepts and discount couponing approaches enhance site or product promotion using incentives, giveaways, promotional offers, etc. that entice consumers to a specific location. Global positioning and navigational technologies can enhance the user's chance and ease of locating places of interest.

One such example is U.S. Patent Application Publication Number 2010/0153008 to Schwartz, et al., which discloses an intelligent travel guide system and an electronic coupon apparatus.

### BRIEF SUMMARY OF THE INVENTION

A method and system for providing predictive discovery services to a user are disclosed. The system includes a user's mobile, hand-held device having a display for displaying signal data and a memory for storing information; a memory, which is remote from the hand-held device, for a database(s) for storing user interest data; and a processing device that is in data communication with the database(s).

The processing device also includes a user interface or application on the users mobile device for allowing user's to input, manually or automatically upload or download personal interest data that can include, without limitation, event and product preferences, user interest criteria, current hand-held device location, and professional and/or event/social calendar information about the user's known future locations at defined times.

The processing device is structured and arranged, inter alia, to identify and provide to the user's mobile device a proximity boundary around experiences in vicinity of the user's known current and future locations as a function of location-time intersections. Each proximity boundary represents a temporal and two-dimensional geographical boundary that is reachable by the user taking into account the user's known current and future locations and his/her professional or event/social calendar.

The processing device further includes a data mining device that is adapted to identify factors of particular interest to the user based on the user's historical, expressed interests input on at least one remote Web-accessible location such as a social media Web site and/or on the user's purchase history and/or buying habits from a business Web site(s). Alternatively, the mining device can be a separate processing device that is capable of sorting and filtering data.

### BRIEF DESCRIPTION OF THE SEVERAL VIEWS OF THE DRAWINGS

Other features and advantages of the invention will be apparent from the following description of the preferred embodiments thereof and from the claims, taken in conjunction with the accompanying drawings, in which:

FIG. 1 shows a block diagram of a predictive discovery system in accordance with the present invention;

FIG. 2 shows a three-dimensional location-time graph in accordance with the present invention;

FIG. 3 shows a flow chart of the proximity alert, Possible/myDAY, and timeRAZOR Recommends discovery mechanisms;

FIGS. 4A-4C show a flow chart of event experience processing and validation in accordance with the present invention; and

FIG. 5 shows a block diagram of an exemplary public event management system (PEMS) in accordance with the present invention.

### DETAILED DESCRIPTION OF THE INVENTION

A predictive discovery system and method are disclosed. The system and method use time variable, known present and future user locations and spatial relationships to determine the best content, e.g., giveaways, public/private events, promotional products/offers, and so forth, to deliver to each consumer/user (hereinafter “user”) via his/her portable or hand-held device. The time-location intersections paradigm provides data, which the system uses in conjunction with user historical or pre-established preference data, as content messages of meaningful, particular interest data unique to each user. For the purpose of illustration and not limitation, these content messages can include real-time proximity alerts, future discovery options that can be arrayed for a 24-hour period (“Possible/myDAY”), for a period of days (“timeRAZOR Recommends”), and so forth.

The system provides predictive discovery services to remote users based on each user's current location, each user's known future location(s), each user's event/social or professional calendar, each user's event and product preferences input by the user or determined by history, and each user's interests that he/she has input on at least one Web location such as a social media or business Web site, e.g., Twitter™, facebook™, Linkedin™, YouTube™, Flickr™, and the like.

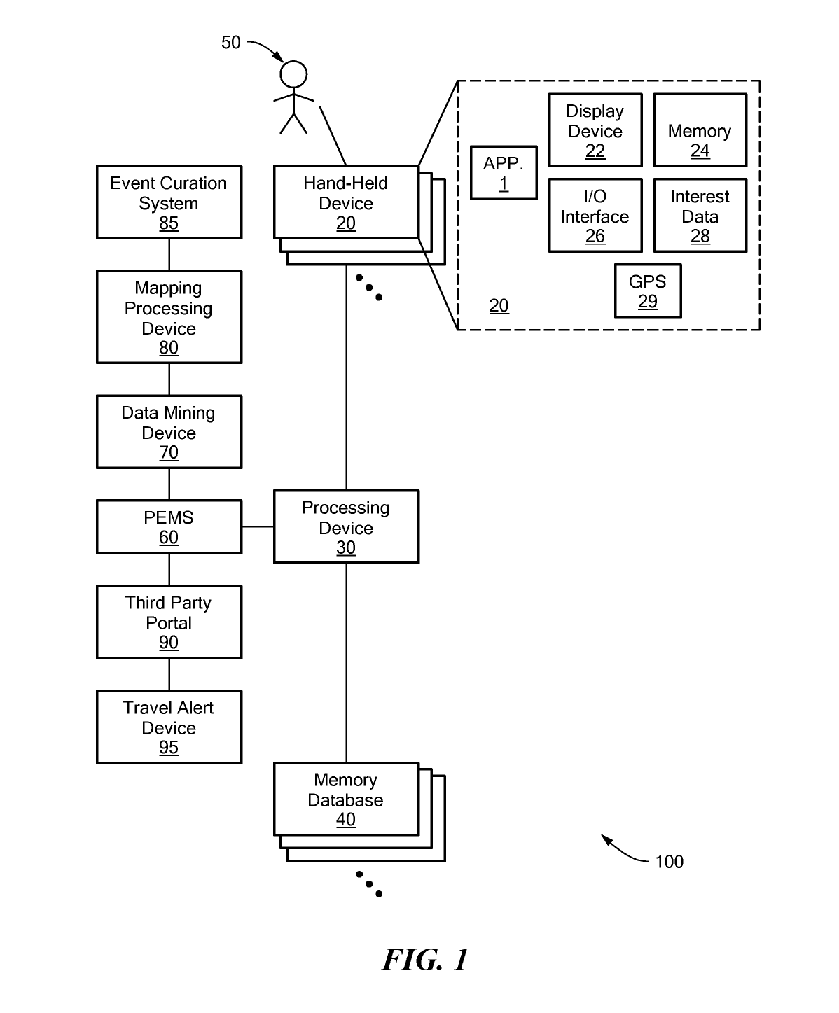

Referring to FIG. 1, the system 100 includes at least one mobile or hand-held device 20, a remote processing device 30 that is in communication with each hand-held device 20, and a remote database(s) 40 that is in electronic communication with the processing device 30 through an application 21 providing an information-grabbing and transmission function to send date described below to the device 30. The hand-held device 20 has a display 22 for displaying and memory 24 for storing information and a user interface 26 that enables user's to input, download or upload user interest data 28. Such user interest data 28 can include, without limitation, event and product preferences, user interest criteria, professional and/or event/social calendar information about the user's future professional and/or personal obligations, and the current hand-held device location from a GPS-type capability 29.

The processing device 30 is adapted to provide general server functions to each hand-held, client device 20 but also to provide predictive discovery services to the remote users 50 via their hand-held devices 20. As will be described in greater detail below, these predictive discovery services are based on the user's known current location, the user's known future location(s) and the time(s) that the user 50 is supposed to be at that location(s), the user's event/social and/or professional calendar, the user's interests and event and product preferences, and the user's interests that he/she has input or expressed on at least one remote accessible Web site, e.g., a social media Web site.

Among the many functions of the processing device 30, chief of which includes defining proximity boundaries around experiences in vicinity of the user's current and known future locations. The proximity boundaries provide an imaginary, geographical boundary about an experience location that is potentially reachable by the user 50, taking into account the user's current and known future locations and an upcoming event time on the user's event calendar. The proximity boundary formation function of the processing device 30 is described in greater detail, infra.

Another important function of the processing device is sorting and providing a likely interest rank order to the giveaways, products, offers, and events whose proximity boundary the user 50 is likely to enter. The sorting and ranking function of the processing device 30 is described in greater detail, infra.

The memory/database 40, which can be a single database or a plurality of coupled databases, is structured and arranged to store, update, and to provide and receive requested data to and from the processing device 30. These data can include, without limitation, information about each user's known current and future locations, each user's social/event or professional calendar, each user's personal and professional interests, each user's event and product preferences, and each user's interests input on at least one public or private accessible remote Web site—typically a social media Web site. In addition, for all users 50, the data can include the date(s), time(s), and location(s) of public/private events, the date(s), time(s), and location(s) of businesses providing giveaways, promotional products or offers, and so forth.

The system 100 further includes a public event management system (PEMS) 60, which will be described in greater detail below in the “Processing and Validation” section, and a data mining device 70, which is adapted to identify factors of discrete interest for the user based on the user's historical, expressed interests input on at least one remote accessible Web site.

The data mining device 70, e.g., a processing device, that is adapted to determine additional user interests based on the user's 50 interests expressed on remote accessible Web sites, e.g., Twitter™, facebook™, Google+™, and the like. This feature requires users 50 who have registered with the system 100 to grant the system 100 permission to access all or some limited but well-defined portion of the user's data on the remote accessible Web site(s).

For example, users 50 register with the system 100 via a mobile device facebook™ (“FB”) connection and, moreover, grant the system 100 certain privileges to his/her data on FB. The processing device 30 and, more specifically, an application, driver program, algorithm, and the like, can then request these data from FB, which data are transmitted, e.g., via a Web service call, to the processing device 30 where they are stored in memory 40. User preference information can be requested from FB, Twitter™, and the like at any time during user 50 interaction with the mobile database in the mobile device 20. These data are transmitted from the mobile database to the processing device 30, e.g., via a Web service call, where they are stored in memory 40, e.g., in a User Profile and Social Graph portion of the database 40. Key to this process is that a user 50 connected to FB returns an authorization token, generally through the FB application programming interface (API), which is used in subsequent Web calls to the FB API along with the user's FB Identifier. Data can be accessed from Twitter in a similar manner. For RapLeaf™ demographic data, a service is called using the user's name and email address. The data returned are stored and integrated into the user profile data as described before. Optionally, analytics ETL (extract, transform, load) routines can further massage, transform, and store the data into different structures to support analytics as well as personalization.

Data can also be mined from a Web application rather than from the mobile application on the user's mobile device 20, e.g., using the same FB APIs and requiring an authorization token to access the user's data on FB and then store it in the database 40.

User profile and social graph data from the remote accessible Web sites can be merged with user interaction with the system 100. Accordingly, one can detect which of a user's accessible remote connections interact with the system 100 and which interact with the same content/experiences as the user 50. Hence, one can determine which of the user's social connections share similar interests, which view content that is shared with the users, and so forth.

In order to provide the user's current location data to the processing device 30 and to provide the user 50 with directional instructions on how to get to a desired location, the system 100 includes a navigation application 29 that is executable on the hand-held device 20 and operative to provide directional instructions to navigate the user 50 to an event or product within the proximity boundary. The invention's application on the device 20 is programmed as is known in the art to access this location information. Navigation applications are well known to those of ordinary skill in the art and need not be described in greater detail.

The system 100 further includes a mapping processing device 80. Such mapping processing devices are adapted to determine a route and to estimate a travel time between the user's current and future locations typically known from the user's calendar information input by the user and read by the application 21; and, moreover, to provide the route to the processing device 30 so that the processing device 30 can investigate and identify a proximity boundary along said route; and to provide the travel time to a travel alert device 95. The travel time alert capability generates a travel time alert based on the user's current location and a location associated with an event on the user's event calendar. Travel alert capabilities are well known to those of ordinary skill in the art and need not be described in greater detail.

The system 100 also includes an event curation system 85 that processes and curates a multiplicity of event and product data based on interest criteria particular to each user, further integrating the event and product data into proximity boundaries. The curation system 85 is described in greater detail in the “Event Scoring” section, infra.

Optionally, the system 100 can include a third-party portal 90 that allows a third-party to manage events and products and to communicate with users 50 through the processing device 30. The third-party portal is described in greater detail in the “Direct Contact Between Third Parties and Users” section, infra.

### Processing and Validation

The system 100 can be populated with experiences, i.e., events, giveaways, promotional offers/items, and the like, that originate from a variety of sources, e.g., public Web sites, event Web sites, users, system employees, third parties/system partners such as businesses using the system to advertise activities, and so forth, and, as a result, some of the experience data may be of dubious or suspect nature. To ensure quality, the system 100 can validate every experience before the experience is broadcast to users. Preferably, automatic validation is performed mechanically on all experiences; however, manual validation is possible by system personnel having access to the device 30. Indeed, experiences that fail automatic validation will be subject to manual validation before being posted or discarded.

Grounds for invalidation can include, without limitation, missing or incorrect information, undesirable or inappropriate content, e.g., profanity, nudity, illegal conduct, and the like, missing or invalid address or contact information, SPAM, and so forth.

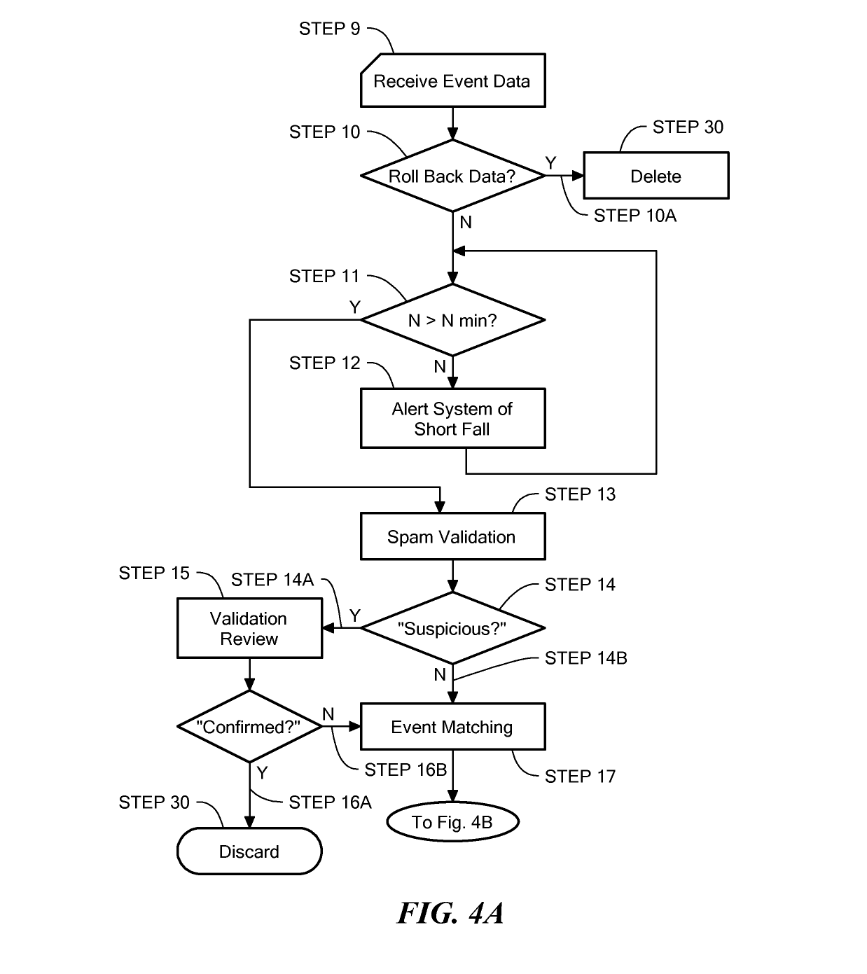

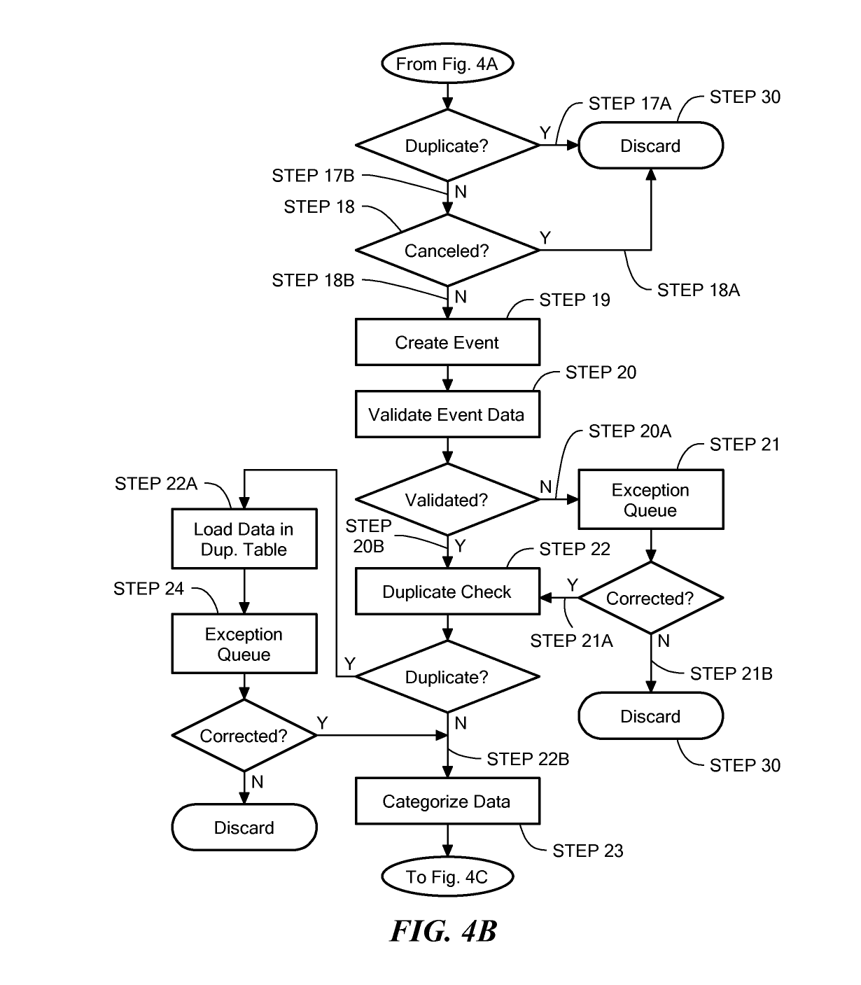

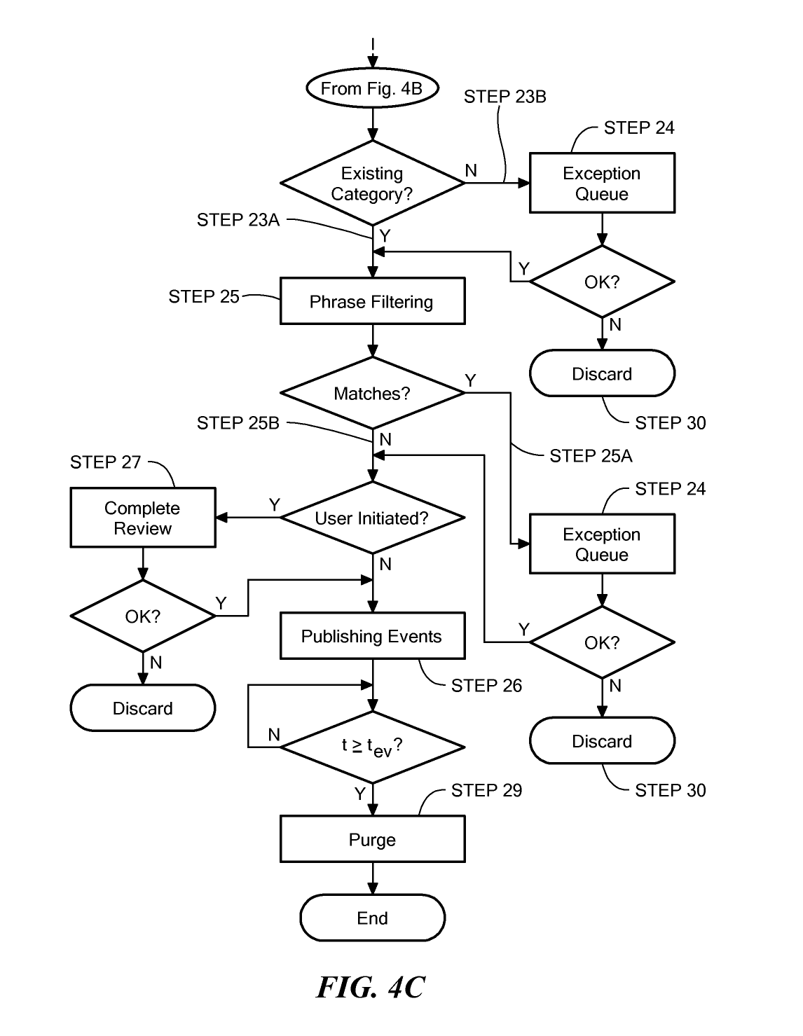

Referring to FIGS. 4A-4C, there are shown flow charts showing exemplary event processing and validation steps for the public event management system (PEMS) 60. The primary function of PEMS 60 is to import, process, and validate potential events before feeding, i.e., pushing, the data of validated events to the processing device 30 of the system 100 for publication to user mobile devices 20.

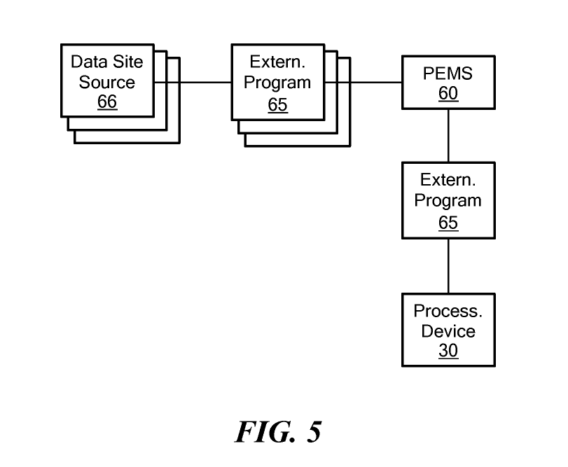

Referring first to FIG. 5, the PEMS 60 includes hardware, middleware, and/or software as well as a processing device(s) with input/output devices, display screens, memory, and the like. The PEMS 60 can be adapted to perform the work described hereinbelow by itself, or, more preferably, the PEMS 60 includes or is in communication with an external program(s) 65, each of which interface with a source of data site 66. The external program(s) 65 is a separate, custom software program (or hardwired device) that is capable of scrapping or calling a source site 66. One external program 66 is also structured and arranged to pull data from the PEMS 60 and to push it into the system 100. The external program(s) 65 pulls/scraps data for a predetermined period of time, e.g., the next thirty days, and passes the data to the PEMS 60. These data can be obtained by mining sources online and are available publicly or by subscription such as local area event calendars or partner input at source site 66. The PEMS 60, in turn, processes the data, which can include looking for duplicate data, looking for cancellation information, updating existing data, categorizing the data, extracting venue information from the data, filtering the data for undesirable events, and so forth.

For example, in a first step, the system 100 receives incoming event data from a source site(s) 66 via the PEMS 60 (STEP 9). From time to time, some data coming into PEMS 60 from a source site(s) 66 may need to be removed. For example, a detected system problem may have corrupted the source data or the data were merely test data or the data failed an initial sanity check and so forth. Hence, at an early stage of the process, it is possible to roll back the event data from a source site(s) 66 (STEP 10). Roll backs (STEP 10A) would be manually executed and would cause all event records for the batch and any venue records created by the batch to be deleted or discarded (STEP 30).

In a second step 11, the total number N of source site event data can be compared to a pre-determined threshold number Nₘᵢₙ of source site event data (STEP 11). As previously mentioned, the timeRAZOR system 100 desires sufficient content to interest users. In the event that the total number of source site event data N is less than the pre-determined threshold number Nₘᵢₙ of source site event data, then an alert message, e.g., an email message, can be dispatched to monitoring employees of the system 100 (STEP 12), informing the monitoring employees that the number of incoming events N is falling below the threshold Nₘᵢₙ for a certain period of time. So they can search further for more event or activity data.

Once the number of incoming events N exceeds the threshold Nₘᵢₙ for a certain period of time, the data are subject to SPAM validation (STEP 13) to identify suspicious or confirmed event data for the purpose of removing the same. For example, if event data appear to be “suspicious” (STEP 14A), the event data are sent to a validation review queue (STEP 15) for manual inspection. If the manual inspection of the data event cannot resolve or confirms that the event data are SPAM (STEP 16A), then the event data are discarded (STEP 30). However, if manual inspection confirms that the event data are not SPAM (STEP 16B) the event data are then screened to learn whether or not the data already exists (STEP 17).

For example, the PEMS 60 looks at incoming event data to determine whether these data have the same source event identification as other data from the same originating source site 66 (STEP 17). If there are identical source event identifications between event data from the same source site 66, then the redundant event data are discarded (STEP 17A). Otherwise, the PEMS 60 determines whether or not the event has been canceled or not (STEP 18). Event data to a canceled event are discarded (STEP 18A).

Otherwise, a new event record is created (STEP 19) using event data that are neither redundant (STEP 17B) nor canceled (STEP 18B). If necessary, a venue record can also be created, but not before a search is performed looking for existing, matching venue records.

The event data for a newly created event are then validated (STEP 20), which is to say that the PEMS 60 ensures that all mandatory fields, e.g., title description, start/end date(s), start/end time(s), category, location information, and the like, contain values. If there are problems with mandatory fields not containing values or containing incorrect values (STEP 25a), then the event data are pushed to the exception queue (STEP 21). Once event data are pushed to the exception queue (STEP 21), the data are manually checked and if possible corrected (STEP 21A). Uncorrectable event data (STEP 21B) are discarded (STEP 30).

Corrected data from the exception queue (STEP 21A) and event data that include properly filled out mandatory fields (STEP 25b) are subject to a more detailed duplicate check (STEP 22). Whereas the previous duplicate check (STEP 17) looked for duplicate data from the same source site 66, the more detailed duplicate check (STEP 22) looks for duplicate event data from multiple source sites 66 for which the source event identification differs. The more detailed duplicate check (STEP 22) is performed using time and address information. Duplicate event data are loaded into a duplication table (STEP 22A) and pushed to the exception queue (STEP 24) for closer, manual scrutiny.

Non-duplicate event data (STEP 22B) are then categorized (STEP 23), e.g., using a category mapping table (STEP 23), unless there is no existing category for the event. Event data that cannot be categorized (STEP 23B) are pushed to the exception queue for manual determination of an appropriate category (STEP 24). Once categorized (STEP 23A), a default link can be linked to the assigned category or an image can be attributed to the category.

Phrase filtering (STEP 25) can now be performed on the categorized event data (STEP 23A). For example, the event title and description can be checked against a list of configured filter phrases (STEP 25). If matches between historical, configured filter phrases and the event title or description are found (STEP 25A) then the event data are pushed to the exception queue for manual determination of a substitute event title or description. Event data are now ready to be pushed to the system 100 for publication (STEP 26) unless the event data were originally submitted by a user 50. User-initiated event data review (STEP 27) is typically manually done before being discarded (STEP 30) or pushed to the system 100 for publication, (STEP 26).

Event data will remain in memory 40 of the system 100 until the event date and time have passed or the event has been rescheduled or canceled (STEP 28). Once the event has been completed (STEP 28A), the event data can be purged from memory (STEP 29).

### Proximity Alert Discovery Mechanism

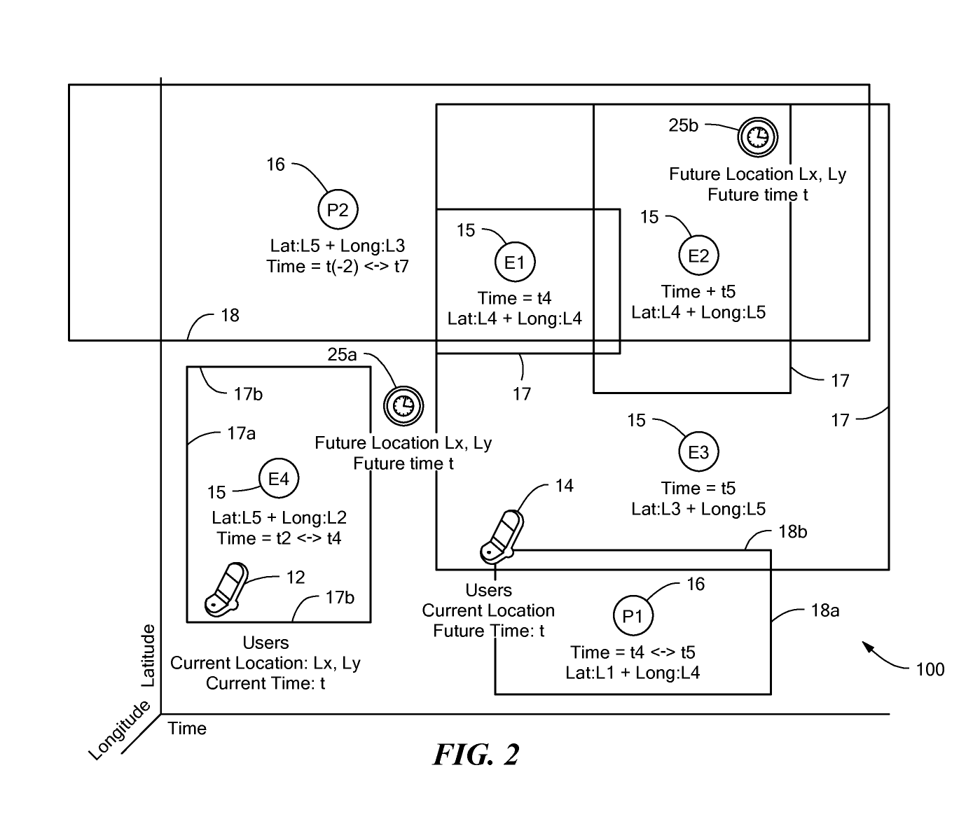

The system 100 and the proximity alert discovery mechanism can best be described by example. Referring to FIG. 2, there are shown a three-dimensional location-time graph and several parts of the system 100. The three-dimensional location-time graph includes positional axes that correspond to longitude and latitude, and a horizontal time axis. Reference numbers 12 and 14, respectively, show the mobile device's 20 current location (Lₓ, L_{y}) at time t₀ and the mobile device's 20 known or predicted future location at a future time t₁. For this particular example, the predicted future location 14 is the same as the current location 12. Hence, both location-time intersections 12, 14 lie in the same plane.

During the time period shown in FIG. 2, there are four events 15 (E1, E2, E3, and E4) and two promotion items/offers 16 (P1 and P2) that occur proximate the user's current location 12 and known or predicted future location 14. Each of the four events 15 and both promotional items/offers 16 takes place at a known, predetermined location, which is defined by a longitude and a latitude, at a predetermined time. The predetermined times can be a fixed time, e.g., time=t₅ for events 15 designated E2 and E3, corresponding, for example, to a starting time to a movie, show, lecture, and the like, or the predetermined times can be variable, e.g., time=t₂<->t₄ for event 15 designated E4, corresponding, for example, to the hours of operation of a store, gallery, museum and the like.

Each of the four events 15 and both promotional items/offers 16 have proximity boundaries 17 and 18, respectively, that the system 100 is adapted to generate. The system-generated proximity boundaries 17 and 18 provide a spatial and temporal window of opportunity that the system 100 can further use, as will be discussed hereinbelow, to determine whether or not a user 50 could participate in the event 15 and/or the promotional items/offers 16.

For example, in one embodiment, the temporal portion of the proximity boundary 17a, 18a is established by the fixed or variable time of the event 15 and/or promotional items/offers 16, while the spatial portion of the proximity boundary 17b, 18b corresponds to the range or distance associated with available travel time needed to travel to the predetermined location of the event 15 and/or promotional items/offers 16, to arrive on time. Optionally, for the temporal portion of the proximity boundary 17a, 18a, the user 50 can, in advance, provide a preference to add—or a default can add—a few minutes, e.g., 15 minutes, to the fixed or variable time of the event 15 and/or promotional items/offers 16 so that the user 50 is comfortably or sociably early for the event 15 and/or promotional items/offers 16.

In operation, the system 100—and more specifically a processing device 30 within the system 100—generates windows of opportunity, i.e., the proximity boundaries 17, 18, for each event 15 and/or promotional items/offers 16 and, further, tracks each user's spatial location 12 with respect to each of the proximity boundaries 17, 18. When the user's current 12 or known future location 14 is within any of the proximity boundaries 17, 18, the system 100 can generate a discovery message signal to the user 50 of his/her proximity of the event 15 and/or promotional items/offers 16. As will be described in greater detail hereinbelow, the system 100 is also structured and arranged to predict future locations 25a, 25b of the user at future times, t₂ and t₃.

For example, referring again to FIG. 2, at time t₀ at a first location-time intersection 12, the current location-time intersection 12 lies within the proximity boundary 17 of event 15 E4; hence, the system 100 can generate a discovery message signal, i.e., prompt, to the user 50 to take part in event 15 E4. At the same location 14 at time t₁, the future location-time intersection 14 lies within the proximity boundary 17 of event 15 E3 as well as within the proximity boundary 18 of promotional items/offers 16 P1. As a result, the system 100 can generate discovery message signals to the user 50 to take part in event 15 E3 and/or in promotional items/offers 16 P1.

As previously mentioned, the system 100 is also adapted to predict future user locations 25a, 25b at future times t₂, t₃, respectively. The system 100 uses these predicted or known future location 25a, 25b and future time t₂, t₃ data to determine whether or not the user 50 will be in a position to take advantage of any future events 15 or promotional items/offers 16. As shown in FIG. 2, a first predicted future location-time intersection 25a does not fall within any proximity boundaries 17, 18. Accordingly, the system 100 would not generate any discovery message signals to the user 50 before future time t₂ unless or until the user 50 were to enter the proximity boundary 17, 18. However, at a second predicted future location-time intersection 25b, the system 100 estimates that the user 50 likely will be in a position to take advantage of events 15 E2 and E3 and/or in promotional items/offers 16 P2. As a result, the system 100 can generate discovery message signals to prompt the user to take part in event 15 E2, event 15 E3, and/or in promotional items/offers 16 P2. Optionally, at the user's discretion, this prompt can include multiple prompts that alert the user 50 to the future possibility well in advance of the event 15 and/or promotional items/offers 16 and that, later, when the user 50 is temporally and geographically closer to the event 15 and/or promotional items/offers 16, to again alert or warn the user 50 of the same.

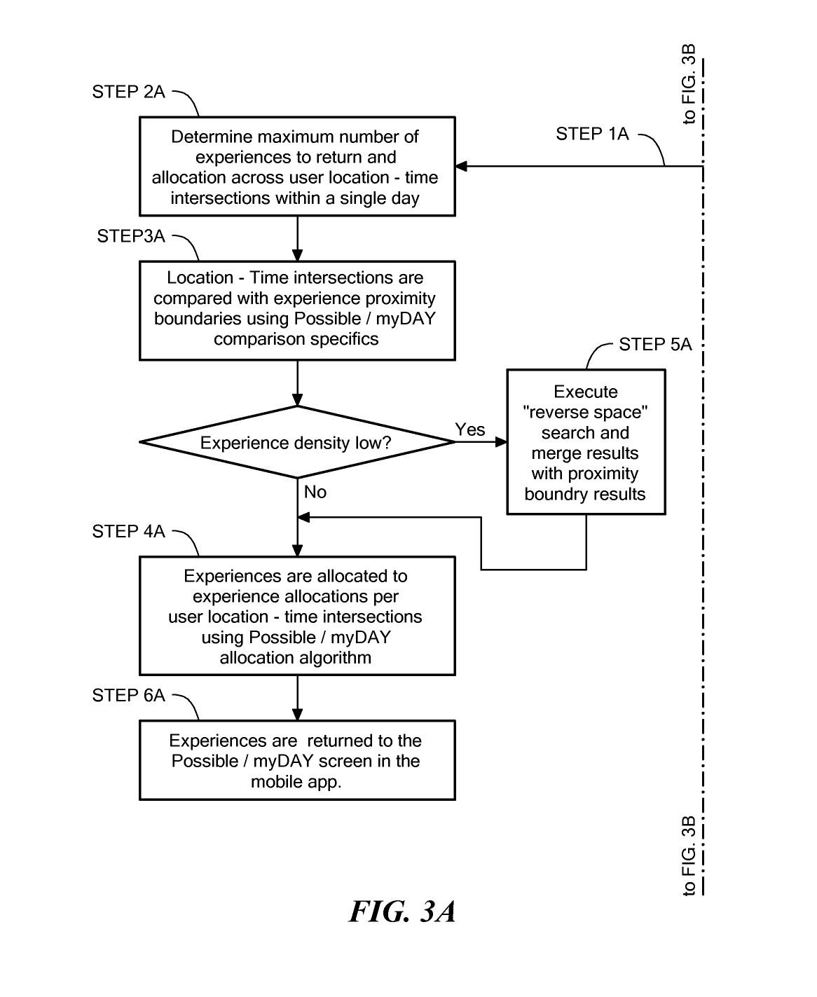

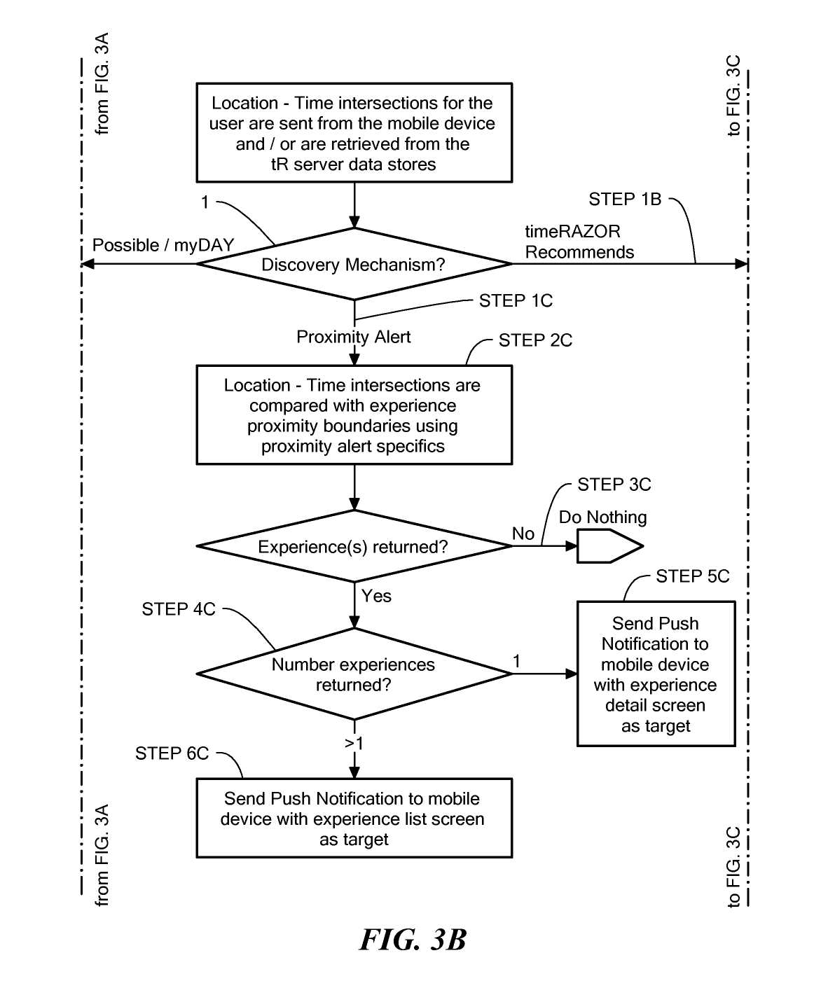

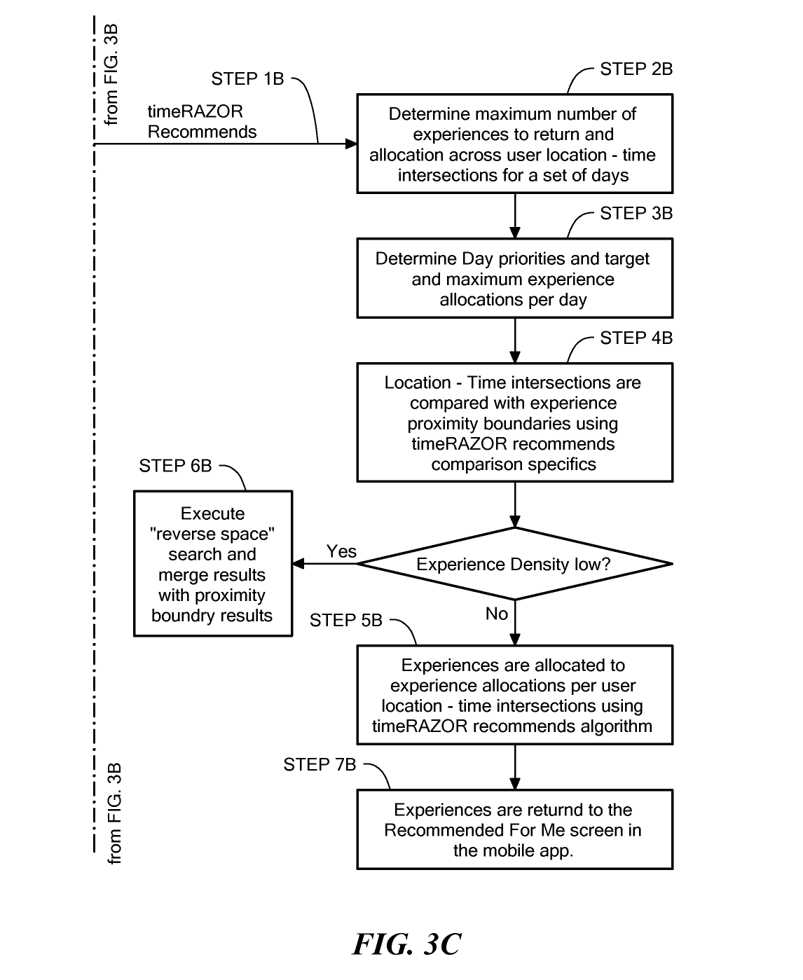

The flow chart in FIG. 3 shows an embodiment of the Proximity Alert mechanism (STEP 1C), which uses the user's current location-time intersection 12 and future location-time intersections 14 to provide proximity alerts. Initially, the system 100 will determine whether or not the user's current location-time intersection 12 falls within any of the proximity boundaries 17, 18 (STEP 2C). If the current location-time intersection 12 does not fall within any proximity boundaries, there are no experiences to transmit to the user 50 and the system 100 does nothing (STEP 3C). For example, in FIG. 2, were the user's current location-time intersection 12 coincident with reference number 25a, the system 100 would do nothing because reference number 25a lies outside all of the proximity limits 17, 18.

On the other hand, if the user's 50 current location-time intersection 12 falls within one of more proximity boundaries, then the system 100 determines the number of experiences that correspond to the user's current location-time intersection 12 (STEP 4C). If the user's current location-time intersection 12 falls within only a single proximity boundary 17, 18, then the system 100 transmits an experience notification to the user's mobile device 20, which the mobile device 20 would display (STEP 5C). For example, in FIG. 2, were the user 50 at current location-time intersection 12, he/she would receive an experience notification about event 15 E4. If the user's current location-time intersection 12 falls within more than one proximity boundary 17, 18, then the system 100 transmits an experience list notification to the user's mobile device 20, which the mobile device 20 would display (STEP 6C). The experience list notification displays a list of all of the possible experiences available to the user 50. For example, in FIG. 2, were the user 50 at location-time intersection 14, he/she would receive an experience list notification about event 15 E3 and product offer 16 P1. By touching the display screen corresponding to any one of the experiences in the experience list, the processing device 30 of the system 100 will then transmit the experience notification corresponding to the selected experience to the user's mobile device 20.

### Possible/myDAY Discovery Mechanism

Whereas the proximity alert discovery mechanism described hereinabove evaluates and filters options for the foreseeable future, i.e., several hours ahead, based on known current and future locations and the user's time schedule, it is also possible to provide users with discovery message signals of events 15 and promotional items/offers 16 for a 24-hour period of time, which is referred to as Possible/myDAY, and for a period of days greater than one, which is referred to as timeRAZOR Recommends. Furthermore, whereas the proximity alert discovery mechanism provides an automatic alert system, each of the Possible/myDAY and timeRAZOR Recommends features is a selectable option on the user's hand-held device 20 via application 21.

Referring to the flow chart in FIG. 3, when a user 50 desires to look ahead at possible discovery experiences within the next 24 hours, he/she can select the Possible/myDAY (STEP 1A) from starting point/link 1. Although the Possible/myDAY will filter possible experiences such as events 15, giveaways, and/or promotional items/offers 16 based on each user's known future locations-time intersections 14, the user 50 is not required to be physically within the proximity boundary 17, 18 of any event(s) 15 and/or promotional items/offers 16 to be alerted.

Initially, the processing device 30 will filter through data in the database 40 as well as user-specific data stored in a Web address network frequented by the user 50 to determine the maximum number of experiences (STEP 2A), e.g., events 15, giveaways, and/or promotional items/offers 16, for the next 24-hour period and for the user's known future location-time intersections 14 based on user calendar input from device 20 as necessary. Because the total number of possible experiences within a busy location can be quite large, the system 100 is preferably structured and arranged so as not to overload users with too many experience options. This, necessarily, requires some prioritization and further filtering before comparing the known future location-time intersections 14 with experience proximity boundaries 17, 18 (STEP 3A).

For example, each user's known future location-time intersections 14 establish temporal and geographical points about which a number of possible “smart” experiences can be determined, e.g., using experience proximity boundaries 17, 18. Smart experiences are events 15, giveaways, and/or promotional items/offers 16 that take place at or near the user's known future location-time intersections 14. If there is a high density of possible smart experiences, the list must be culled or filtered to allocate potential experiences occurring within the next 24 hours for each known location-time intersection 14 (STEP 4A). Here again, allocation attempts to ensure no user overload of data.

Proximity of the smart experience to the user 50 remains a primary factor in this analysis (STEP 4A). More specifically, whether or not the user 50 is within the proximity boundary 17, 18 of the experience is of primary importance. Beyond that, each experience can be objectively and/or subjectively scored (described hereinbelow) based on pre-established criteria and historical user preferences and the experiences can be ranked in order from highest to lowest based on these scores. Preferably, the processing device 30 is adapted to filter the data to ensure that some number (n+m) of experiences is provided for each known future location-time intersection 14 and, moreover, that there is a good balance of experiences, i.e., a number n of events 15 and a number m of giveaways and/or promotional items/offers 16, as well.

In the off chance that there are either no experiences for one or more of the user's known future location-time intersections 14 or if the density of experiences is relatively low, the processing device 30 is structured and arranged to perform a “reverse space” search (STEP 5A). A reverse space search (STEP 5A) ignores proximity boundaries 17, 18, which are based on the location-time metric of the experience, and, instead, focuses on the user 50, the user's current location 12 or, alternatively, the user's residence. The reverse space search (STEP 5A) establishes user-specific boundaries, the limits of which can be measured in miles or, alternatively, in a one-way or round-trip travel time. In short, the reverse space search (STEP 5A) extends the search area for experiences that are reachable by the user 50 to provide more experience options when the experience density is low.

Once the density of the experience pool has been made artificially high via a reverse space search (STEP 5A), it remains to objectively and/or subjectively score each experience based on pre-established criteria and historical user preferences and to rank-order the returned experiences from the highest score to the lowest score and to allocate some of the experiences (STEP 4A) to a user 50. Here again, as part of the allocation process (STEP 4A), the processing device 30 is adapted to filter data to ensure that some number (n+m) of experiences is provided for each known future location-time intersection 14 and, moreover, that there is a good balance of experiences, i.e., a number n of events 15 and a number m of giveaways and/or promotional items/offers 16. Here again, allocation (STEP 4A) attempts to ensure no user overload of data.

Having allocated experiences for each of the user's known future location-time intersections 14, it only remains for the processing device 30 to transmit these data to the user's hand-held device 20 (STEP 6A) for display.

timeRAZOR Recommends Discovery Mechanism

Referring again to the flow chart in FIG. 3, when a user desires to look ahead at possible discovery experiences within a period of days, he/she can select the timeRAZOR Recommends option (STEP 1B). Advantageously, each user may individually select the number of future days to be included in the period and can limit the number of experiences to identify during the period of days. If the user 50 does not make such selections, the timeRAZOR Recommends discovery mechanism can have a default, e.g., ten days and twenty experiences. Although the timeRAZOR Recommends discovery mechanism will filter possible experiences such as events 15, giveaways, and/or promotional items/offers 16 based on each user's future locations-time intersections 14, the user 50 is not required to be physically within the proximity boundary 17, 18 of any event(s) 15 and/or promotional items/offers 16.

As with the Possible/myDAY discovery mechanism, the processing device 30 will filter through data in the database 40 as well as user-specific data mined from remote accessible Web sites frequented by the user 50 to determine the maximum number of experiences (STEP 2B), e.g., events 15, giveaways, and/or promotional items/offers 16, for the period of days and for the user's known future location-time intersections 14. Unlike the Possible/myDAY discovery mechanism, however, certain days of the week are more socially active than others and, as a result, the timeRAZOR Recommends discovery mechanism can be adapted to prioritize certain experiences on these high activity dates (STEP 3B), i.e., Fridays and Saturdays, rather than on the lower activity days, i.e., Tuesday and Wednesday.

As before, because the total number of available experiences within a busy location can be quite large, the system 100 should be structured and arranged so as not to overload users with too many experience options. This, necessarily, requires some prioritization and further filtering before comparing the known future location-time intersections 14 with experience proximity boundaries 17, 18 (STEP 4B).

For example, each user's known future location-time intersections 14 establish temporal and geographical points about which a number of possible “smart” experiences can be determined, e.g., using experience proximity boundaries 17, 18. If there is a high density of possible smart experiences, the list must be culled or filtered to allocate potential experiences occurring within the period of days for each known location-time intersection 14 (STEP 5B). Here again, allocation attempts to ensure no user overload of data. Repetition of a single experience on multiple days during the period of days is also precluded so that no single event(s) overshadows other available events.

Proximity of the smart experience to the user 50 remains a primary factor in this analysis (STEP 5B). More specifically, whether or not the user 50 is within the proximity boundary 17, 18 of the experience is of primary importance. Beyond that, each experience can be objectively and/or subjectively scored (described hereinbelow) based on pre-established criteria and historical user preferences and the experiences can be ranked in order from highest to lowest based on these scores. Preferably, the processing device 30 is adapted to filter the data to ensure that some number (n+m) of experiences is provided for each known future location-time intersection 14 and, moreover, that there is a good balance of experiences, i.e., a number n of events 15 and a number m of giveaways and/or promotional items/offers 16, as well.

In the off chance that there are either no experiences for one or more of the user's future location-time intersections 14 or if the density of experiences is relatively low, the processing device 30 is structured and arranged to perform a “reverse space” search (STEP 6B). Once the density of the experience pool has been made artificially high via a reverse space search (STEP 6B), it remains to objectively and/or subjectively score each experience based on pre-established criteria and historical user preferences and to rank-order the returned experiences from highest to lowest and to allocate some of the experiences (STEP 5B) to a user. Here again, as part of the allocation process (STEP 5B), the processing device 40 is adapted to filter data to ensure that some number (n+m) of experiences is provided for each known future location-time intersection 14 and, moreover, that there is a good balance of experiences, i.e., a number n of events 15 and a number m of giveaways and/or promotional items/offers 16. Here again, allocation (STEP 5B) attempts to ensure no user overload of data.

Having allocated experiences for each of the user's known future location-time intersections 14, it only remains for the processing device 30 to transmit these data to the user's hand-held device 20 (STEP 7B) for display.

### Event Scoring

Experiences, which include events 15, giveaways, promotional items/offers 16, and the like, are input, uploaded or downloaded into the processing device 30 and/or memory 40. Experiences can be added by the owner of the processing device 30 and/or by third parties who desire to make their experiences available to system 100 users. The processing device 30 is adapted to import and/or create a multiplicity of experiences and, further, to perform geo-coding, scoring, and other curation features on the experiences. Once the processing device 30 or the PEMS 60 has completed all of this processing, the experience would be available for “publication” on hand-held devices 20.

Event experiences 15 are scored manually or, more preferably, automatically and in real time. Giveaways and/or promotional items/offers 16 are not scored. Event scoring can be formed by any one of or a combination of: category matching, venue matching, and/or word and phrase matching. Category matching provides points to an event 15 as a function of the timeRAZOR category of the event 15, e.g., concert, public speech, movie, and so forth. Hence, all incoming data for events 15 are first categorized from which the events 15 receive the category portion of their overall score.

With venue matching, points are allocated to events that take place at certain discrete venues within a geographical area that is served by the system 100. Hence, after incoming data for events 15 receive the category portion of their overall score, the events 15 may receive additional points depending on the venue.

Finally, certain events and types of events are subjectively deemed to be of lesser or greater interest. Those deemed to be of greater interest receive more points than those deemed to be of lesser interest.

For example, for the purpose of illustration assume that a user 50 has a dinner engagement downtown at 8 p.m. and that the user's future location-time intersection 14 places him/her in the proximity boundaries 17, 18 of 20 possible events 15, but, due to the desire not to overburden users 50, only six of which can be displayed. If two events 15 have scores of 400, six events 15 have scores of 300, and ten events 15 have scores of 200, then the processing device 30 initially will select the events 15 with the highest scores, which is to say, the two events 15 with scores of 400 and the six events 15 with scores of 300. The numbers are exemplary only. To further cull these eight events 15 down to just six, filtering the six, 300-point events based on distance to the events 15 will determine the four closest events 15 of the six. Accordingly, the processing device 30 will offer the user 50 the two 400-point events 15 and the four 300-point events 15 that are closest geographically.

Optionally, the processing device 30 can override the normal decision making process that is based on scores to take into account the user's mood. A mood feature enables the user 50 to input his/her current mood (e.g. happy, serious, music, sports, etc.) or input something he/she is particularly interested in at that time to device memory 40. Once a user 50 selects a mood, the processing device 30 calls up the category or categories associated with that particular mood. The processing device 30 will, as before, rank-order the results from the category search as a function of score and distance. In this way, an event 15 having a lower score but in a specific, mood category will trump an event 15 with a higher score but that is not in the desired mood category.

Personalization is yet another feature of the system 100 that allows the processing device 30 to override the normal, score-based decision making process. Personalization prevents events 15 from certain low-score categories from always being excluded from display because the events 15 within that category generally have lower scores than events 15 in high-score categories. With personalization, the scores of events 15 that are consistent with the personal tastes and interests of the user 50 are biased to reflect the user's expressed interests and the user's interests expressed on social media sources.

Personalization works at three levels: at the category and venue interest level, through clustering techniques, and at a keyword and location level. The latter two levels deal with artificial intelligence and machine learning techniques having to do with associating an experience that may be of interest to a discrete user 50 based on what other users 50 with similar interests as the discrete user 50 also have expressed an interest in (clustering analysis) and with using user-specific keywords to promote other experiences that contain the same words, respectively.

The first two levels use event scoring once a user's particular interests have been established. At the keyword level, artificial intelligence factors that are created by the learning algorithms in the processing device 30 can be used to adjust event scores. For example, events included the keyword “springsteen” may receive additional points if the term “springsteen” is among the user's list of most frequently detected keywords.

### Direct Contact Between Third Parties and Users

Optionally, the system 100 can also be adapted to enable third parties, e.g., business partners, to contact users 50 indirectly via the third-party portal 90 and the processing device 30 with experiences. The process is user-initiated. Hence, the process begins with a user 50 initiating an ALERT ME! message from the mobile Web browser on his/her hand-held device 20. Alternatively, the user can 50 initiate ALERT ME! messaging while on the third party's Web site using any processor or microprocessor.

When the latter is the case, the third party's Web site can include any number of experiences, any one or more of which the user 50 can request to be alerted on, providing an email address, which would not be necessary were the ALERT ME! message to originate from the user's mobile, hand-held device 20. Either way, the request generates a Web service call by which the ALERT ME! Identifier and the user's email address are sent to the processing device 30 and saved in a memory database 40 provided for that purpose. The processing device 30 further responds to the Web service call by transmitting an acknowledgement back to the user 50.

Non-users requesting an ALERT ME! message would automatically become users; have an account established for them; and have a downloadable application (App 21) transmitted to them. The ALERT ME! Identifier automatically is added to the requester's professional and/or event/social calendar by date, time, and location data.

If the ALERT ME! message has to do with giveaways, promotional offers/items 16, and so forth, the system automatically reserves the giveaway(s), promotional offer(s)/item(s) 16 for the requester. Furthermore, the processing device 30 of the system 100 generates proximity boundaries 18 about location(s) of the giveaways, promotional offers/items 16, etc. Hence, whenever the user 50 physically enters the proximity boundary 18 at some future date and time, the processing device 30 will automatically send him/her an ALERT ME! proximity alert message, reminding him/her of the giveaway(s), promotional offer(s)/item(s) 16 ready to be picked up and the location of the pick-up. Once the user 50 actually journeys to the location and redeems the giveaway(s), promotional offer(s)/item(s) 16, the ALERT ME! message associated with that particular giveaway(s), promotional offer(s)/item(s) 16 is automatically removed from the user's professional and/or event/social calendar, applicable memory, and so forth.

Although preferred embodiments of the invention have been described above, it will be recognized and understood that various modifications may be made in the invention and that the appended claims are intended to cover all such modifications which fall within the spirit and scope of the invention.

What I claim is:

1. A system for providing predictive discovery services to a user, the system comprising:
a mobile, hand-held device having a display for displaying information, memory for and storing information, and a user interface for allowing input of user interest data comprising event and product preferences, user interest criteria, current hand-held device location, and event calendar information about future occurrences and locations for events and products;
at least one database remote from the hand-held device for storing the user interest data;
a processing device in data communication with said database that is structured and arranged to identify at least one proximity boundary about the future occurrences and locations for events and products, the proximity boundary providing a geographical boundary around said future occurrences and locations for events and products that is reachable by the user taking into account the user's current and future locations and an upcoming event on the user's event calendar; and
a data mining device that is adapted to identify factors of discrete interest for the user based on the user's historical, expressed interests input on at least one remote accessible Web site.

2. The system as recited in claim 1 further comprising a mapping processing device that is capable of:
determining a route and estimating a travel time between the user's current and future locations; and
providing the route to the processing device for creating the proximity boundary along said route; and
providing the travel time to the travel time alert device to the travel alert device.

3. The system as recited in claim 1 further comprising a device for providing a rank order to the plurality of products and events within the user's proximity boundary based on the user's event and product preferences, the user's predetermined criteria, and the user's factors of discrete interest.

4. The system as recited in claim 1 further comprising an event curation system that processes and curates a multiplicity of event and product data, integrating said multiplicity into the user's proximity boundary based on the user's event and product preferences, the user's predetermined criteria, and the user's factors of discrete interest.

5. The system as recited in claim 1 further comprising a third-party portal that is structured and arranged to allow a third-party to manage events and products by providing notifications to the user.

6. The system of claim 1 wherein said processing device includes a travel time alert capability that is structured and arranged to generate a travel time alert based on the user's current location and a location associated with an event on the user's event calendar.

7. The system as recited in claim 1 further comprising a navigation application that is executable on the hand-held device and operative to provide directional instructions to navigate the user to an event or product within the proximity boundary, in proximity of the user's current or future locations.

8. The system as recited in claim 1, further comprising a public event management system that processes and validates all event experience data originating from a plurality of source sites before the event experience data are available to be transmitted to the user.

9. The system as recited in claim 8, wherein the public event management system is adapted to perform at least one of:
alerting the system if a number of incoming event experience data is less than a pre-established threshold number;
screening incoming event experience data for SPAM;
matching incoming event experience data against other incoming event experience data from a common originating source site for duplicate event experiences;
matching incoming event experience data against other incoming event experience data from a different originating source site for duplicate event experiences;
creating a new event experience from the event experience data;
categorizing each validated event experience;
performing phrase filtering on each validated event experience to determine if the event experience already exists;
transmitting the validated event experience data to the processing system; and
purging the validated event experience data once the validated event experience has occurred, been re-scheduled or been canceled.

10. A method of for providing predictive discovery services to a user having a user-accessible mobile device with a display for displaying and storing information and with a user interface for allowing input of user interest data comprising activity, event and product preferences, user interest criteria, current mobile device location, and calendar information about future occurrences and locations for activities, events, giveaways, and product offers, the method comprising:
mining user-specific interest data based on the user's historical, shown interests that have been input on at least one publicly or privately accessible Web site using a processing device;
storing mined user-specific interest data, user interest data, and/or user interest data based on user history for the user in at least one database remote from the hand-held device;
determining a current location-time intersection of the user;
establishing a location-time proximity boundary about each experience selected from among the future occurrences and locations for activities, events, giveaways, and product offers, wherein the proximity boundary of each selected experience defines a geographical boundary that is reachable by the user taking into its location and its time of occurrence;
determining whether or not the user's current location-time intersection falls within any of the location-time proximity boundaries; and
providing an experience notification to the user's mobile device when user's current location-time intersection falls within any of the location-time proximity boundaries.

11. The method as recited in claim 10, wherein providing an experience notification to the user's mobile device includes at least one of:
providing an experience list of possible experiences from which the user can choose to receive more information; and
providing details of the experience as a description of the experience and as to the location and time of occurrence.

12. The method as recited in claim 10 further comprising:
determining at least one of the user's future location-time intersections from a professional or social event calendar used by the user;
determining whether or not any of the user's future location-time intersection falls within any of the location-time proximity boundaries about each experience;
identifying a number of experiences when user's future location-time intersection falls within any of the location-time proximity boundaries; and
limiting the number of experiences before providing the experience notification to the user's mobile device.

13. The method as recited in claim 12, wherein the user's future location-time intersections are determined for a period of time selected from the group comprising:
a 24-hour period; or
a period of days more than a single day.

14. The method as recited in claim 12, wherein if the number of experiences identified is less than a predetermined threshold number, the method further comprises:
performing a reverse space search that establishes a location-time proximity boundary about the user's current location-time intersection;
identifying any reverse space experiences located within the user's location-time proximity boundary; and
merging the reverse space experiences with other identified experiences.

15. The method as recited in claim 12, wherein limiting the number of experience notifications includes at least one of:
providing experience notifications for only a pre-established number of experiences per day;
providing a balance of experience notifications that includes some number of activities, some number of events, some number of giveaways, and some number of product offers; and
providing experience notifications based on scoring each of the experiences and rank-ordering said experiences.

16. The method as recited in claim 15, wherein scoring each of the event experiences includes allocating a pre-established number of points for a category that the event falls within, a number of points for a venue at which the event occurs, and a number of points for keywords and key phrases in the description of the event.

17. The method as recited in claim 10 further comprising validating all event experience data originating from a plurality of source sites before said event experience data are included among the future occurrences and locations.

18. The method as recited in claim 17, wherein validation includes at least one of:
alerting the system if a number of incoming event experience data is less than a pre-established threshold number;
screening incoming event experience data for SPAM;
matching incoming event experience data against other incoming event experience data from a common originating source site for duplicate event experiences;
matching incoming event experience data against other incoming event experience data from a different originating source site for duplicate event experiences;
creating a new event experience from the event experience data;
categorizing each validated event experience;
performing phrase filtering on each validated event experience to determine if the event experience already exists;
transmitting the validated event experience data to the processing system; and
purging the validated event experience data once the validated event experience has occurred, been re-scheduled or been canceled.

19. The method as recited in claim 10 further comprising at least one of:
determining a route and estimating a travel time between the user's current and future locations;
providing the route to the processing device for creating the proximity boundary along said route;
providing the travel time to the travel time alert device to the travel alert device;
curating a multiplicity of event and product data;
integrating said multiplicity into the user's proximity boundary based on the user's event and product preferences, the user's predetermined criteria, and the user's factors of discrete interest;
providing a travel time alert capability that is structured and arranged to generate a travel time alert based on the user's current location and a location associated with an event on the user's event calendar; and
providing directional instructions to navigate the user to an event or product within the proximity boundary, in proximity of the user's current or future locations.

20. A system for providing predictive discovery services to a user, the system comprising:
a user accessible mobile device having a display for displaying information, a memory for storing information, and a user interface for allowing input of user interest data comprising activity, event and product preferences, user interest criteria, current mobile device location, and calendar information about future occurrences and locations for activities, events, and products;
at least one database remote from the hand-held device for accessing and storing the user interest data and/or user interest data based on user history;
a processing device in data communication with said database and said mobile device that is structured and arranged to identify a proximity boundary about the future occurrences and locations for events and products, the proximity boundary providing a geographical boundary around said future occurrences and locations for events and products that is reachable by the user taking into account the user's current and future locations and an upcoming event on the user's event calendar; and
said processing device having a data mining function that is adapted to identify factors of discrete interest for the user based on the user's historical, shown interests on at least one publicly or privately accessible Web site for addition to user interest data;
said processing device providing to said mobile device for display through said user interface data of time and/or location based alerts to said user of activities, events, and/or products related to user interest data.

21. A system for providing a user, via a user mobile device, information relating to accessibility to activities of interest by accessing through remote devices information indicating user interest available from user input of interest information and third party Web sites having user data indicating user interests.

22. A method for providing a user, via a user mobile device, information relating to accessibility to activities of interest by accessing through remote devices information indicating user interest available from user input of interest information and third party Web sites having user data indicating user interests.
